(19) United States
(12) Patent Application Publication
(10) Pub. No.: US 2010/0329391 A1
(43) Pub. Date: Dec. 30, 2010

(54) INFORMATION DETECTING APPARATUS AND METHOD

(75) Inventors: Hirotoshi Fukuda, Yokohama (JP); Junichi Iida, Tokyo (JP); Masato Sano, Tokyo (JP); Toshinori Arai, Komae (JP)

Correspondence Address: MCDERMOTT WILL & EMERY LLP, 600 13TH STREET, N.W., WASHINGTON, DC, 20005-3096, US

(73) Assignee: HITACHI - LG DATA STORAGE, INC.

(21) Appl. No.: 12/769,351

(22) Filed: Apr. 28, 2010

(30) Foreign Application Priority Data
Jun. 29, 2009 (JP) 2009-154357

(51) Int. Cl. H04L 25/06

(52) U.S. Cl. 375/319; 375/340

(57) ABSTRACT

Proposed are a highly reliable information detecting apparatus and an information detecting method. This information detecting apparatus includes a high pass filter unit configured in a manner of being able to freely change a time constant and for extracting a high frequency content of the communication signal, a squelch detection unit for detecting a region in which a signal level of the high frequency component of the communication signal exceeds a predetermined squelch detection threshold, an information detection unit for detecting the information superposed on the communication signal based on a detection output of the squelch detection unit, a DC fluctuation detection unit for detecting a level fluctuation of a DC component of the communication signal, a control unit for controlling the high pass filter to lower the time constant of the high pass filter unit when the level fluctuation of the DC component of the communication signal is detected by the DC fluctuation detection unit, and a mask unit for masking the detection output of the squelch detection unit so as to make it appear that the squelch detection unit has not detected a region exceeding the squelch detection threshold while the control unit is lowering the time constant of the high pass filter unit.

### CROSS REFERENCES

This application relates to and claims priority from Japanese Patent Application No. 2009-154357, filed on Jun. 29, 2009, the entire disclosure of which is incorporated herein by reference.

The present invention generally relates to an information detecting apparatus and method and, for example, can be suitably applied to a receiving apparatus that is compliant with the Serial ATA (Advanced Technology Attachment) standard.

### BACKGROUND

Conventionally, as a method of connecting a host computer (hereinafter referred to as the “host”) and a storage device such as an optical disk device or a hard disk device (hereinafter referred to as the “device”), Serial ATA as a high-speed serial transfer protocol standard has been formulated.

With the Serial ATA standard, negotiation referred to as the OOB (Out of Band) sequence is conducted prior to the data transfer. The OOB sequence is performed according to the following routine shown in FIG. 8.

Specifically, foremost, after the host is turned on, it sends a COMRESET signal to the device. When the device receives the COMRESET signal, it sends a COMINIT signal to the host. Subsequently, when the host receives the COMINIT signal, it sends a COMWAKE signal to the device, and, when the device receives the COMWAKE signal, it sends a COMWAKE signal to the host.

As described above, the foregoing negotiation is conducted by repeating the operation of the host or the device detecting the respective signals sent by the other. Data transfer is started when the negotiation is performed normally. The COMRESET signal, the COMWAKE signal and the COMINIT signal are collectively referred to as the OOB signal.

The OOB signal is a signal that repeats a period (burst period) of a constant length in which a burst signal defined in the Serial ATA standard is transmitted, and a no-signal period (space period), and the length of the burst period and the space period as well as the frequency thereof are defined in the standard.

Specifically, the burst period and the space period of the COMRESET signal and the COMINIT signal are approximately 106.7 [ns] and approximately 320 [ns], respectively, and the number of burst periods is 6 times. Meanwhile, the burst period and the space period of the COMWAKE signal are approximately 106.7 [ns], respectively, and the number of burst periods is 6 times. Generally speaking, a receiving apparatus that is compliant with the Serial ATA standard determines that an OOB signal has been detected upon detecting the burst period and the space period 3 times or more in succession.

In relation to the foregoing Serial ATA communication, Japanese Published Unexamined Application No. 2006-203338 (Patent Document 1) discloses a method of preventing a false detection of the OOB signal by using a squelch detection circuit.

### SUMMARY

Meanwhile, with a communication system that performs communication in compliance with the Serial ATA standard (hereinafter referred to as the “Serial ATA communication system”), when there is a level fluctuation in the DC component of the communication signal that is sent, by way of differential transmission, from the sending device to the receiving apparatus, there are cases where the receiving apparatus-side falsely detects an OOB signal or is unable to accurately detect an OOB signal, and there is a problem in terms of the reliability being insufficient.

The present invention was devised in view of the foregoing points. Thus, an object of this invention is to propose a highly reliable information detecting apparatus and method.

In order to achieve the foregoing object, the present invention provides an information detecting apparatus for detecting information from a communication signal in which a burst period of transmitting a burst signal and a space period as a no-signal period are repeated in a pattern according to the subject matter of the information. This information detecting apparatus comprises a high pass filter unit configured in a manner of being able to freely change a time constant and for extracting a high frequency content of the communication signal, a squelch detection unit for detecting a region in which a signal level of the high frequency component of the communication signal exceeds a predetermined squelch detection threshold, an information detection unit for detecting the information superposed on the communication signal based on a detection output of the squelch detection unit, a DC fluctuation detection unit for detecting a level fluctuation of a DC component of the communication signal, a control unit for controlling the high pass filter to lower the time constant of the high pass filter unit when the level fluctuation of the DC component of the communication signal is detected by the DC fluctuation detection unit, and a mask unit for masking the detection output of the squelch detection unit so as to make it appear that the squelch detection unit has not detected a region exceeding the squelch detection threshold while the control unit is lowering the time constant of the high pass filter unit.

The present invention additionally provides an information detecting method of an information detecting apparatus including a high pass filter unit configured in a manner of being able to freely change a time constant and for extracting a high frequency content of the communication signal, a squelch detection unit for detecting a region in which a signal level of the high frequency component of the communication signal exceeds a predetermined squelch detection threshold, and an information detection unit for detecting the information superposed on the communication signal based on a detection output of the squelch detection unit, and for detecting information from a communication signal in which a burst period of transmitting a burst signal and a space period as a no-signal period are repeated in a pattern according to the subject matter of the information. This information detecting method comprises a first step of detecting a level fluctuation of a DC component of the communication signal, a second step of controlling the high pass filter unit to lower the time constant of the high pass filter unit when the level fluctuation of the DC component of the communication signal is detected, and a third step of masking the detection output of the squelch detection unit so as to make it appear that the squelch detection unit has not detected a region exceeding the squelch detection threshold while the time constant of the high pass filter unit is being lowered.

According to the present invention, it is possible to realize a highly reliable information detecting apparatus and method.

### DESCRIPTION OF DRAWINGS

FIG. 1 is a block diagram showing an example of the configuration of a conventional Serial ATA communication system;

FIG. 2 is a waveform diagram showing a waveform of various signals in the Serial ATA communication system of FIG. 1;

FIG. 3 is a waveform diagram showing a waveform of various signals in the Serial ATA communication system of FIG. 1;

FIG. 4 is a block diagram showing the overall configuration of a Serial ATA communication system according to the first embodiment;

FIG. 5 is a waveform diagram showing a waveform of various signals in the Serial ATA communication system of FIG. 4;

FIG. 6 is a waveform diagram showing a waveform of various signals in the Serial ATA communication system of FIG. 4;

FIG. 7 is a block diagram showing the configuration of a receiving apparatus according to the second embodiment; and

FIG. 8 is a diagram explaining the OOB (Out of Band) sequence.

### DETAILED DESCRIPTION

An embodiment of the present invention is now explained in detail with reference to the attached drawings.

### (1) First Embodiment

### (1-1) Configuration Example of Conventional Serial ATA Communication System

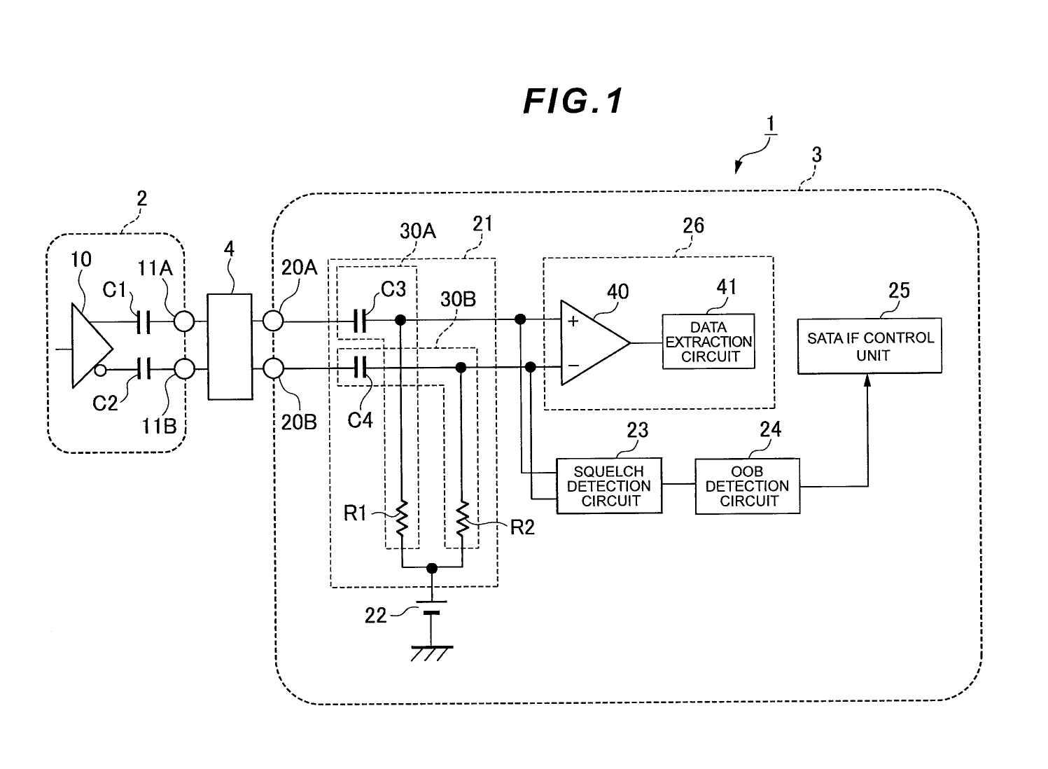

FIG. 1 shows a configuration example of a conventional Serial ATA communication system. The Serial ATA communication system 1 comprises a sending device 2 and a receiving apparatus 3 which are compliant with the Serial ATA standard, and configured by the sending device 2 and the receiving apparatus 3 being connected via a Serial ATA cable 4.

The sending device 2 comprises an output amplifier 10, and first and second AC coupling capacitors C1, C2. The sending device 2 sends a normal phase side of a communication signal subject to differential output from an output amplifier 10 (hereinafter referred to as the “normal phase side communication signal”) to the Serial ATA cable 4 via the first AC coupling capacitor C1 and a first output terminal 11A, and sends a reverse phase side of a communication signal that is output from an inverted output terminal of the output amplifier 10 (hereinafter referred to as the “reverse phase side communication signal”) to the Serial ATA cable 4 via the second AC coupling capacitor C2 and a second output terminal 11B.

The receiving apparatus 3 comprises first and second input terminals 20A, 20B, a high pass filter unit 21, a bias supply 22, a squelch detection unit 23, an OOB detection unit 24, a Serial ATA interface control unit 25, and a data extraction unit 26.

The high pass filter unit 21 comprises a first high pass filter circuit 30A configured from a third capacitor C3 connected in series to the first input terminal 20A, and a first termination resistor R1, and a second high pass filter circuit 30B configured from a fourth capacitor C4 connected in series to the second input terminal 20B, and a second termination resistor R2. The first input terminal 20A is provided with a normal phase side communication signal and the second input terminal 20B is provided with a reverse phase side communication signal of the normal phase side communication signal and the reverse phase communication signal which are sent, via differential transmission, from the sending device 2 via the Serial ATA cable 4. Moreover, the first and second termination resistors R1, R2 are commonly connected to the positive electrode side of the bias supply 22 to which the negative electrode side is grounded.

Consequently, the high pass filter unit 21 extracts a high frequency component of the normal phase side communication signal, superposes a bias voltage according to the output voltage of the bias supply 22 to the extracted high frequency component, and outputs this as a normal phase side high frequency component signal from the connection midpoint of the third AC coupling capacitor C3 and the first termination resistor R1. Further, the high pass filter unit 21 extracts a high frequency component of the reverse phase side communication signal, superposes the foregoing bias voltage to the extracted high frequency component, and outputs this as a reverse phase side high frequency component signal via the connection midpoint of the fourth AC coupling capacitor C4 and the second termination resistor R2.

The squelch detection circuit 23 inputs the normal phase side high frequency component signal and the reverse phase side high frequency component signal which are output from the high pass filter unit 21, and determines whether the absolute value of the differential of the signal levels of the normal phase side high frequency component signal and the reverse phase side high frequency component signal exceeds a predetermined threshold (threshold of an input signal in which the squelch detection circuit 23 is able to normally perform squelch detection; hereinafter referred to as the “squelch detection circuit tolerance input signal threshold”). The squelch detection circuit 23 creates a squelch detection signal in which the period where the absolute value of the differential is greater than the squelch detection circuit tolerance input signal threshold rises to a logical level of “1” and the period where the absolute value of the differential is less than the squelch detection circuit tolerance input signal threshold drops to a logical level of “0,” and sends this to the OOB detection circuit 24.

The OOB detection circuit 24 monitors the squelch detection signal, and measures the pulse width (corresponds to the burst period), number of successive pulses (corresponds to the number of burst periods) and the pulse interval (corresponds to the space period), respectively, of the respective pulses that rise to a logical level of “1” at the respective parts (that is, the respective burst periods of the OOB signal) in which the logical level included in that squelch detection signal is “1.” The OOB detection circuit 24 thereafter respectively compares the pulse width and pulse interval of the respective pulses obtained from the foregoing measurement with the burst period and the space period of the COMRESET signal, the COMWAKE signal and the COMINIT signal defined in the Serial ATA standard, and, upon detecting three or more pulses in succession in which both the pulse width and the pulse interval obtained from the foregoing measurement coincide with the time specified as the burst period and the space period of the COMRESET signal, the COMWAKE signal or the COMINIT signal defined in the Serial ATA standard, it sends a corresponding OOB detection signal to the Serial ATA interface control unit 25.

Specifically, when the OOB detection unit 24 detects three or more pulses in succession in which the pulse width is approximately 106.7 [ns] and the interval is approximately 320 [ns], it determines that a COMRESET signal or a COMINIT signal has been received, and sends a corresponding OOB detection signal to the Serial ATA interface control unit 25. Meanwhile, when the OOB detection unit 24 detects three or more pulses in succession in which the pulse width is approximately 106.7 [ns] and the interval is approximately 160.7 [ns], it determines that a COMWAKE signal has been received, and sends a corresponding OOB detection signal to the Serial ATA interface control unit 25.

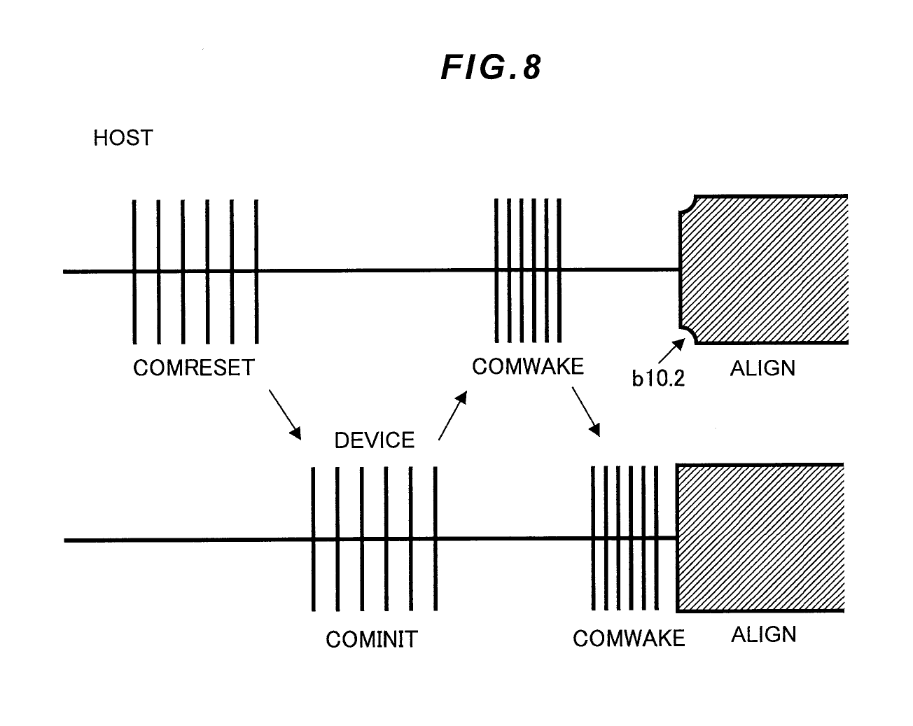

The Serial ATA interface control unit 25 determines the status of input of the COMRESET signal, the COMRESET signal or the COMINIT signal based on the OOB detection signal provided from the OOB detection circuit 24, and executes the prescribed processing concerning the OOB sequence described above with reference to FIG. 8 as needed based on the determination result.

Meanwhile, the data extraction unit 26 is configured from a data extraction difference amplifier 40 and a data extraction block 41.

With the data extraction difference amplifier 40, a noninverted input terminal is connected to the connection midpoint of the third AC coupling capacitor C3 and the first termination resistor R1 of the high pass filter unit 21, and an inverted input terminal is connected to the connection midpoint of the fourth AC coupling capacitor C4 and the second termination resistor R2 of the high pass filter unit 21. The data extraction difference amplifier 20 sends, to the data extraction block 41, a differential signal according to the differential of the signal levels of the normal phase side high frequency component signal provided from the high pass filter unit 21 to the noninverted input terminal and the reverse phase side high frequency component signal provided from the high pass filter unit 21 to the inverted input terminal.

Based on the control of the Serial ATA interface control unit 25, the data extraction block 41 extracts data contained in the differential signal provided from the data extraction difference amplifier 20 and sent from the sending device 2 after the receiving apparatus 3 completes the OOB sequence with the sending device 2.

With the conventional Serial ATA communication system configured as described above, when viewing the overall system, the high pass filter is configured from the first AC coupling capacitor C1 of the sending device 2 and the third AC coupling capacitor C3 and the first termination resistor R1 of the receiving apparatus 3, and the high pass filter is configured from the second AC coupling capacitor C2 of the sending device 2 and the fourth AC coupling capacitor C4 and the second termination resistor R2 of the receiving apparatus 3.

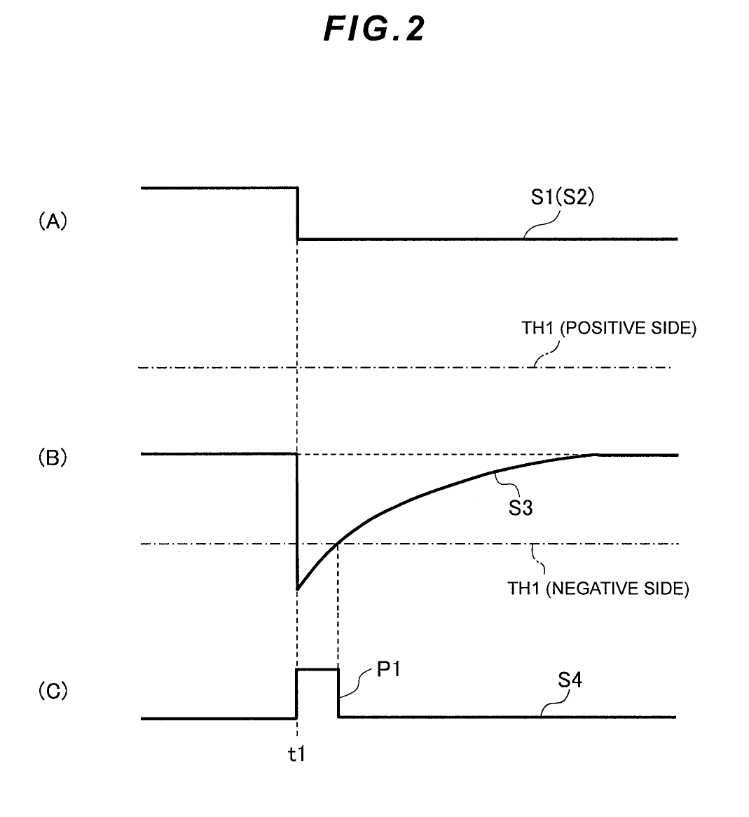

Thus, as shown in FIG. 2A, if a fluctuation arises in the DC component of the normal phase side communication signal S1 and the reverse phase side communication signal S2 as a result of the sending device 2 being shut down or other reasons (time t1), a sawtooth level fluctuation as shown in FIG. 2B will be generated in the normal phase side high frequency component signal and the reverse phase side high frequency signal which are output from the high pass filter unit 21 of the receiving apparatus 3. In connection with this, a similar level fluctuation will also be generated in the differential signal S3 which is based on the differential of the normal phase side high frequency component signal and the reverse phase side high frequency signal.

If the foregoing level fluctuation that was generated in the differential signal S3 exceeds the squelch detection circuit tolerance input signal threshold TH1 in which the squelch detection circuit 23 is able to normally perform squelch detection, as shown in FIG. 2C, a pulse P1 that rises during the period that the signal level of the differential signal S3 exceeds the squelch detection circuit tolerance input signal threshold TH1 is generated in the squelch detection signal S4 that is output from the squelch detection circuit 23, and, depending on the conditions, there was a possibility that the OOB detection circuit 24 would falsely detect the pulse P1 as an OOB signal.

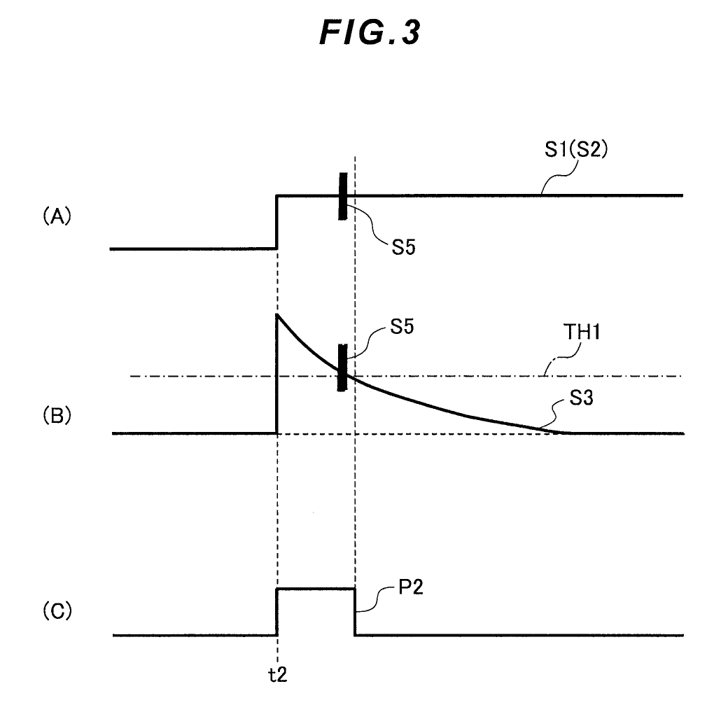

Moreover, as shown in FIG. 3A, if an OOB signal S5 is sent from the sending device 2 to the receiving apparatus 3 immediately after a level fluctuation arises in the DC component of the normal phase side communication signal S1 and the reverse phase side communication signal S2 (time t2), as shown in FIG. 3B, there are cases where the OOB signal S5 is input to the squelch detection circuit 23 in a state where the differential signal S3 exceeds the squelch detection circuit tolerance input signal threshold TH1. In the foregoing case, as shown in FIG. 3C, since a squelch detection signal S4 including a pulse P2 that rises for a period that the differential signal S3 is exceeding the squelch detection circuit tolerance input signal threshold TH1, there is a problem in that the OOB detection circuit 24 is unable to detect the OOB signal S5.

As one method of overcoming the foregoing problems, for instance, considered may be a method of creating the system so that the period in which the differential signal S3 exceeds the squelch detection circuit tolerance input signal threshold TH1 will be as short as possible, and masking the pulses P3, P4 that are generated in the squelch detection signal S4 during the foregoing period using some sort of method. According to the foregoing method, even in cases where the OOB signal S5 is sent from the sending device 2 to the receiving apparatus 3 immediately after the generation of a level fluctuation in the DC component of the normal phase side communication signal S1 and the reverse phase side communication signal S2 as shown in FIG. 3A, it should be possible to mask only the pulse arising in the squelch detection signal S4 due to the foregoing level fluctuation without having to mask the OOB signal.

In the foregoing case, the convergence time of the level fluctuation generated in the normal phase side high frequency component signal output from the first high pass filter circuit 30A of the receiving apparatus 3 due to the level fluctuation of the DC component of the normal phase side communication signal S1 and the reverse phase side communication signal S2 as shown in FIG. 2A can be calculated as the time constant T of the high pass filter configured from the first AC coupling capacitor C1 of the sending device 2 and the third AC coupling capacitor C3 and the first termination resistor R1 of the receiving apparatus 3. The foregoing time constant T can be sought according to the following formula when the capacity of the first AC coupling capacitor C1 of the sending device 2 is C_{T1}, the capacity of the third AC coupling capacitor C3 of the receiving apparatus 3 is C_{R1}, and the resistance value of the first termination resistor R1 of the receiving apparatus 3 is R_{R1}.

[Formula 1]

T={1/(1/C_{T1}+1/C_{R1})}×R_{R1} (1)

Moreover, the convergence time of the level fluctuation generated in the reverse phase side high frequency component signal output from the second high pass filter circuit 30B of the receiving apparatus 3 can similarly be sought.

Accordingly, as a result of reducing the total value of the capacity of the first AC coupling capacitor C1 of the sending device 2 and the capacity of the third AC coupling capacitor C3 of the receiving apparatus 3, and/or reducing the resistance value of the first termination resistor R1 of the receiving apparatus 3, the time constant T of the high pass filter that is configured from the foregoing first and third AC coupling capacitors C1, C3 and the first termination resistor R1 can be lowered, and the time constant of the high pass filter configured from the second AC coupling capacitor C2 of the sending device 2 and the fourth AC coupling capacitor C4 and second termination resistor R2 of the receiving apparatus 3 can also be lowered based on a similar method.

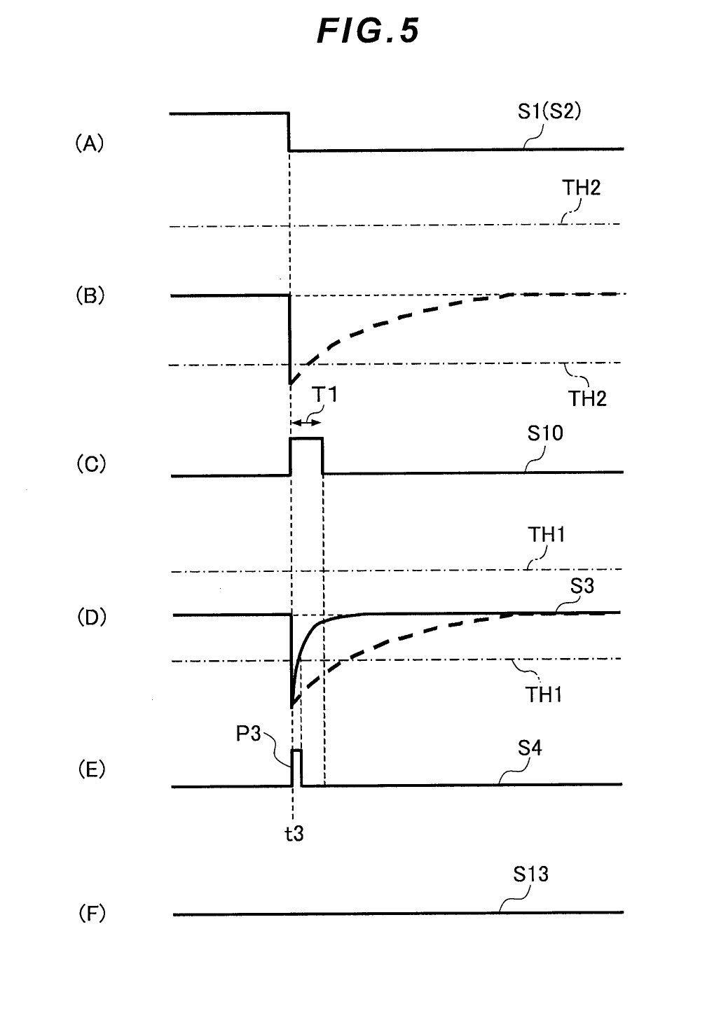

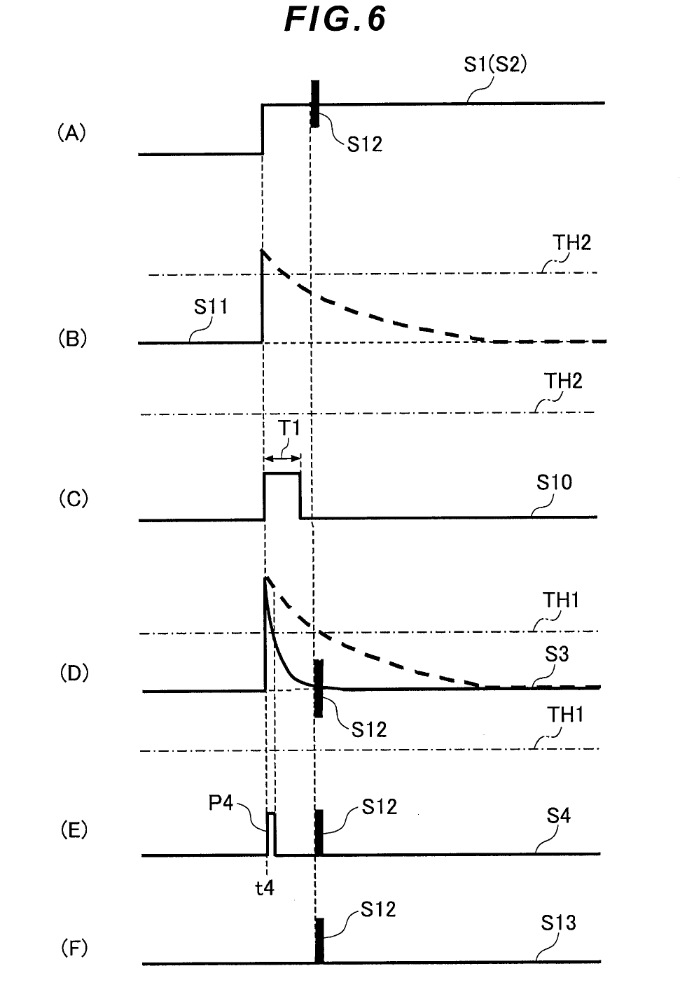

Consequently, as a result of shortening the convergence time of the level fluctuation generated in the normal phase side high frequency component signal and the convergence time of the level fluctuation generated in the reverse phase side high frequency component signal according to the foregoing method, for instance, as shown in FIG. 5C and FIG. 6C, it is possible to shorten the period that the differential signal S3, which is the differential of the normal phase side high frequency component signal and the reverse phase side high frequency component signal, exceeds the squelch detection circuit tolerance input signal threshold TH1 due to the level fluctuation of the DC component of the normal phase side communication signal and the reverse phase side communication signal.

However, to reduce the capacity of the third and fourth AC coupling capacitors C3, C4 of the high pass filter unit 21 or the resistance value of the first and second termination resistors R1, R2 will lead to the deterioration in the signal quality of the normal phase side communication signal and the reverse phase side communication signal to be received by the receiving apparatus 3 side. Thus, it would be insufficient to merely reduce the capacity or the resistance value from the initial state.

Thus, with the Serial ATA communication system of this embodiment is loaded with a function of causing the receiving apparatus 3 side to monitor the level of the DC component of the normal phase side communication signal and the reverse phase side communication signal, temporarily lowering the time constant of the first and second high pass filter circuits 30A, 30B in the high pass filter unit 21 when a level fluctuation is generated in the DC component, and masking the squelch detection signal that is output from the squelch detection circuit 23 at such time. The Serial ATA communication system according to this embodiment loaded with the foregoing function is now explained.

### (1-2) Serial ATA Communication System According to this Embodiment

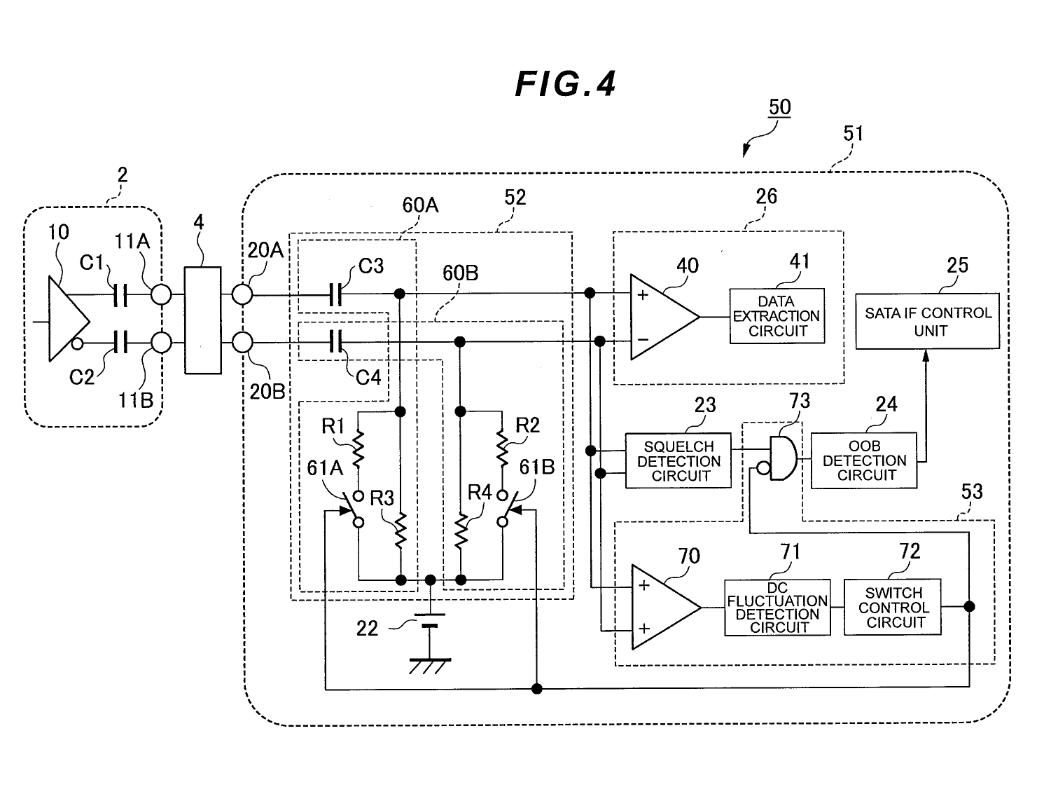

FIG. 4 in which the same reference numerals are given to the corresponding components of FIG. 1 shows the Serial ATA communication system 50 according to this embodiment. The Serial ATA communication system 50 is configured the same as the Serial ATA communication system 1 described above with reference to FIG. 1 excluding the point that the configuration of the high pass filter unit 52 of the receiving apparatus 51 is different, and the point that a switch control unit 53 has been added to the receiving apparatus 51.

In reality, in the case of this Serial ATA communication system 50, a first time constant reduction resistor R3 and a first switch 61A connected in parallel to the first termination resistor R1 are provided to the first high pass filter circuit 60A of the high pass filter unit 52 of the receiving apparatus 51, and a second time constant reduction resistor R4 and a second switch 61B connected in parallel to the second termination resistor R2 are provided to the second high pass filter circuit 60B.

The first and second switches 61A, 61B are configured to be of a closed state when the logical level of a switch control signal is “0” and to be of an open state when the logical level of a switch control signal is “1” based on the switch control signal described later which is provided from the switch control unit 53.

The switch control unit 53 is configured from a summing amplifier 70, a DC component fluctuation detection circuit 71, a switch control circuit 72 and a mask gate 73.

With the summing amplifier 70, one input terminal is connected to the connection midpoint of the third AC coupling capacitor C3 and the first termination resistor R1 of the high pass filter unit 52, and the other input terminal is connected to the connection midpoint of the fourth AC coupling capacitor C4 and the second termination resistor R2 of the high pass filter unit 52. The summing amplifier 70 adds the normal phase side high frequency component signal provided from the high pass filter unit 53 to the one input terminal, and the reverse phase side high frequency component signal provided from the high pass filter unit 53 to the other input terminal. Consequently, the information component contained in the normal phase side communication signal and the information component contained in the reverse phase side communication signal will be set off, and a signal (hereinafter referred to as the “fluctuation added signal”) to which the fluctuation of the DC component of the normal phase side communication signal and the fluctuation of the DC component are added can be obtained. Thus, the summing amplifier 70 sends the fluctuation added signal obtained as described above to the DC fluctuation detection circuit 71.

The DC fluctuation detection circuit 71 detects the status of the level fluctuation of the respective DC components of the normal phase side communication signal and the reverse phase side communication signal based on the supplied fluctuation added signal. Specifically, the DC fluctuation detection circuit 71 compares the signal level of the fluctuation added signal with a predetermined threshold (hereinafter referred to as the “fluctuation detection threshold”). If the signal level of the fluctuation added signal becomes greater than the fluctuation detection threshold, the DC fluctuation detection circuit 71 sends a corresponding level fluctuation detection signal to the switch control circuit 72.

The switch control circuit 72 controls the first and second switches 61A, 61B to be in an open state, under normal circumstances, by sending a switch control signal having a logical level of “0” to the first and second switches 61A, 61B of the high pass filter unit 52. If the switch control circuit 72 recognizes that the signal level of the fluctuation added signal became greater than the fluctuation detection threshold (a level fluctuation of a certain level or greater is generated in the DC component of the normal phase side communication signal and the reverse phase side communication signal) based on the level fluctuation detection signal provided from the DC fluctuation detection circuit 71, it switches the logical level of the switch control signal to “1” for a predetermined period of time (hereinafter referred to as the “masking time”), and thereby shifts the first and second switches 61A, 61B of the high pass filter unit 52 to a closed state for the duration of the masking time.

The mask gate circuit 73 is configured from an AND gate circuit including a noninverted input terminal and an inverted input terminal, and inputs the squelch detection signal output from the squelch detection circuit 23 into the noninverted input terminal, and inputs the switch control signal output from the switch control circuit 72 into the inverted input terminal. The mask gate circuit 73 sends, as a mask gate signal, the OR of the squelch detection signal and a signal in which the switch control signal is inverted to the OOB detection circuit 24.

Accordingly, in a normal state, since a switch control signal having a logical level of “0” is provided from the switch control circuit 72 to the inverted input terminal of the mask gate circuit 73, a mask gate signal of the same logical level as the squelch detection signal is output from the mask gate circuit 73, and this is provided to the OOB detection circuit 24. When the switch control circuit 72 recognizes that a level fluctuation has been generated in the DC component of the normal phase side communication signal and the reverse phase side communication signal, since the logical level of the switch control signal is switched to “1” for the duration of the foregoing masking time, even in cases where a pulse (pulse P1 of FIG. 2C or pulse P2 of FIG. 3C) caused by the foregoing level fluctuation is generated in the squelch detection signal, such pulse will be masked and the mask gate circuit 73 will provide a mask gate signal having a logical level of “0” to the OOB detection circuit 24.

In the foregoing configuration, as shown in FIG. 5A, if a level fluctuation arises in the DC component of the normal phase side communication signal S1 and the reverse phase side communication signal S2 output from the output amplifier 10 of the sending device 2 in the Serial ATA communication system 50 (time t3), as shown in FIG. 5B, this level fluctuation is detected in the DC fluctuation detection unit 71 of the switch control unit 53 of the receiving apparatus 51 based on the fluctuation added signal S10, and a corresponding fluctuation detection signal is provided to the switch control circuit 72. The switch control circuit 72 switches the logical level of the switch control signal S11 from “0” to “1” for the duration of the masking time T1 as shown in FIG. 5C based on the foregoing fluctuation detection signal.

Here, the first and second switches 61A, 61B of the high pass filter unit 52 become a closed state according to the switching of the logical level of the switch control signal S11. When the first and second switches 61A, 61B become a closed state, the first time constant reduction resistor R3 is connected in parallel to the first termination resistor R1, and the second time constant reduction resistor R4 is connected in parallel to the second termination resistor R2. Consequently, the resistance value of the overall high pass filter configured from the first AC coupling capacitor C1 of the sending device 2 and the third AC coupling capacitor C3 and first termination resistor R1 of the receiving apparatus 51, and the resistance value of the high pass filter configured from the second AC coupling capacitor C2 of the sending device 2 and the fourth AC coupling capacitor C4 and second termination resistor R2 of the receiving apparatus 51 will respectively become smaller than their original resistance values, and the time constant of these two high pass filters will decrease. Thereby, as shown in FIG. 5D, the time that the differential signal S3, which is the differential of the normal phase side high frequency component signal and the reverse phase side high frequency component signal, exceeding the squelch detection circuit tolerance input signal threshold TH1 due to the level fluctuation of the DC component of the normal phase side communication signal S1 and the reverse phase side communication signal S2 can be shortened.

In the foregoing case, as shown in FIG. 5D, although a pulse P3 that rises during the period that the differential signal S3 is exceeding the squelch detection circuit tolerance input signal threshold TH1 will be generated in the squelch detection signal S14, as shown in FIG. 5E, since the logical level of the mask gate signal S13 output from the mask gate circuit 73 at such time will constantly be “0,” the pulse P3 will not be input into the OOB detection circuit 24, and the OOB detection signal 24 will not falsely detect an OOB signal based on the pulse P3.

Moreover, for example, as shown in FIG. 6A, even in cases where the OOB signal S12 is sent from the sending device 2 to the receiving apparatus 51 immediately after a fluctuation arises in the DC component of the normal phase side communication signal S1 and the reverse phase side communication signal S2 (time t4), since the time that the differential signal S3 exceeds the squelch detection circuit tolerance input signal threshold TH1 is shortened, as shown in FIG. 6B to FIG. 6F, it is possible to provide the mask gate signal S13, which masks only the pulse P4 that was generated in the squelch detection signal S4, to the OOS detection circuit 24 without having to mask the OOB signal S12.

As described above, according to this embodiment, since the receiving apparatus 51 side of the Serial ATA communication system 50 monitors the level fluctuation of the DC component of the normal phase side communication signal and the reverse phase side communication signal, the first or second time constant reduction resistor R3, R4 is connected in parallel to the third and fourth termination resistors R3, R4 in the high pass filter unit 52 when the foregoing level fluctuation is generated, and the squelch detection signal output from the squelch detection circuit 23 is masked, it is possible to prevent the OOB detection circuit 24 from falsely detecting the OOB signal due to the level fluctuation of the DC component of the normal phase side communication signal and the reverse phase side communication signal, and thereby create a highly reliable Serial ATA communication system.

### (2) Second Embodiment

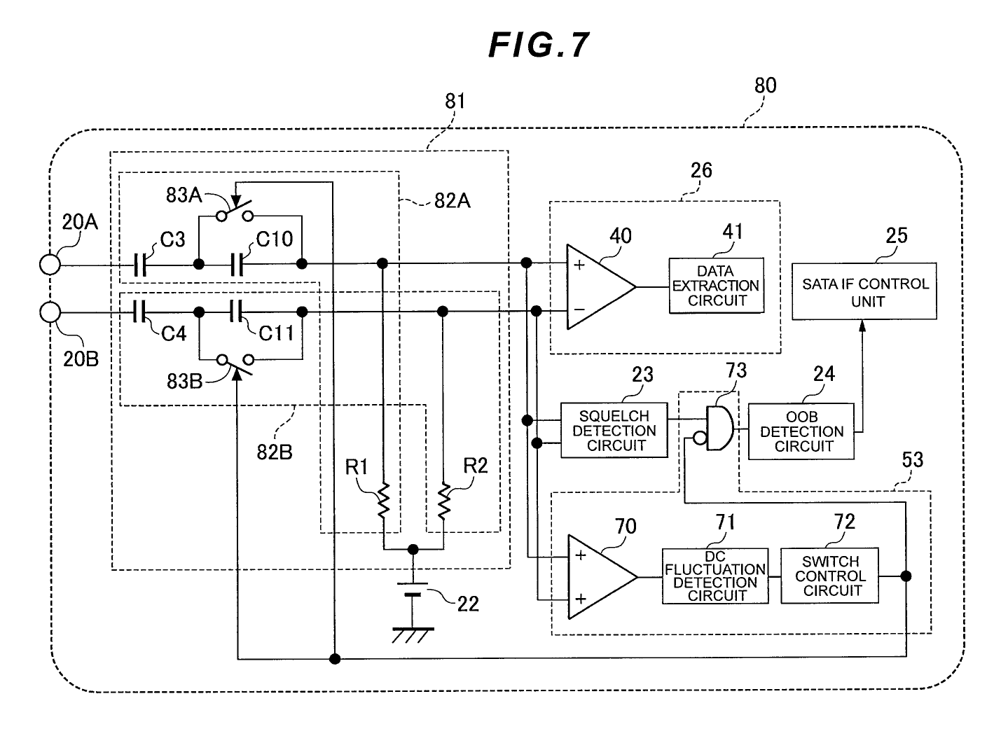

FIG. 7 in which the same reference numerals are given to the corresponding components of FIG. 4 shows a receiving apparatus 80 according to the second embodiment to be applied to the Serial ATA communication system 50 in substitute for the receiving apparatus 51 of FIG. 4. The receiving apparatus 80 is configured the same as the receiving apparatus 51 of the first embodiment excluding the point that the configuration of the first and second high pass filter circuits 82A, 82B of the high pass filter unit 81 is different.

Specifically, in the case of the receiving apparatus 80 according to this embodiment, the first high pass filter circuit 82A is configured from a third AC coupling capacitor C3, a first time constant reduction capacitor C10 and a first termination resistor R1 which are connected directly to the first input terminal 20A, and a first switch 83A that is connected in parallel to the first time constant reduction capacitor C5, and the second high pass filter circuit 82B is configured from a fourth AC coupling capacitor C4, a second time constant reduction capacitor C11 and a first termination resistor R2 which are connected directly to the second input terminal 20B, and a second switch 83B that is connected in parallel to the second time constant reduction capacitor C11.

The first and second switches 83A, 83B are configured to be of a closed state when the signal level of a switch control signal is logical “0” and to be of an open state when the signal level of a switch control signal is logical “1” based on the switch control signal provided from the switch control circuit 72 of the switch control unit 53.

Thereby, with the receiving apparatus 80, based on the switch control signal output from the switch control circuit 72, in a normal state, the first and second switches 83A, 83B of the first and second high pass filter circuits 82A, 82B are closed, and the first and second switches 83A, 83B are opened when a level fluctuation is generated in the DC component of the normal phase side communication signal and the reverse phase side communication signal.

In the foregoing configuration, since the first and second switches 83A, 83B are closed in a normal state, the capacitance of the high pass filter configured from the first AC coupling capacitor C1 of the sending device 2 and the third AC coupling capacitor C3 and first termination resistor R1 of the receiving apparatus 51 will be dependent on the respective capacities of the first and third AC coupling capacitors C1, C3, and the capacitance of the high pass filter configured from the second AC coupling capacitor C2 of the sending device 2 and the fourth AC coupling capacitor C4 and the first termination resistor R2 of the receiving apparatus 51 will be dependent on the respective capacities of the second and fourth AC coupling capacitors C2, C4.

Meanwhile, when a level fluctuation is generated in the DC component of the normal phase side communication signal and the reverse phase side communication signal, a first time constant reduction capacitor C10 is connected in series to the third capacitor C3, and a second time constant reduction capacitor C11 is connected in series to the fourth capacitor C4, and the capacitance of the high pass filter configured from the first AC coupling capacitor C1 of the sending device 2 and the third AC coupling capacitor C3 and first termination resistor R1 of the receiving apparatus 51, and the capacitance of the high pass filter configured from the second AC coupling capacitor C2 of the sending device 2 and the fourth AC coupling capacitor C4 and first termination resistor R2 of the receiving apparatus 51 will both be smaller than their original capacitance.

Consequently, since the time constant of these two high pass filters will decrease, the time that the differential signal, which is the differential of the normal phase side high frequency component signal and the reverse phase side high frequency component signal, exceeds the squelch detection circuit tolerance input signal threshold due to the level fluctuation being generated in the DC component of the normal phase side communication signal and the reverse phase side communication signal can be shortened.

In addition, since the logical level of the switch control signal that is input into the inverted input terminal of the mask gate circuit 73 will also be switched from “0” to “1” for the duration of the foregoing masking time, even if a pulse caused by the differential signal as the differential of the normal phase side high frequency component signal and the reverse phase side high frequency component signal exceeding the squelch detection circuit tolerance input signal threshold TH1 (FIG. 5 and FIG. 6) during the masking time is output from the squelch detection circuit 23 and a squelch detection signal is created, since the logical level of the mask gate signal output from the mask gate circuit 73 is constantly “0” as described above, the foregoing pulse will not be input into the OOB detection circuit 24, and the OOB detection circuit 24 will not falsely detect an OOB signal based on the mask gate signal.

As described above, according to this embodiment, since the receiving apparatus 80 side of the Serial ATA communication system monitors the level fluctuation of the DC component of the normal phase side communication signal and the reverse phase side communication signal, the first or second time constant reduction capacitor C10, C11 is connected in parallel to the third and fourth AC coupling capacitors C3, C4 in the high pass filter unit 81 when the foregoing level fluctuation is generated, and the squelch detection signal output from the squelch detection circuit 23 is masked, the same effects as the first embodiment can be obtained.

### (3) Other Embodiments

Although the foregoing first and second embodiments explained a case of lowering the time constant of the high pass filter configured from the first AC coupling capacitor C1 of the sending device 2 and the third AC coupling capacitor C3 and first termination resistor R1 of the receiving apparatuses 51, 80 and the high pass filter configured from the second AC coupling capacitor C2 of the sending device 2 and the fourth AC coupling capacitor C4 and second termination resistor R2 of the receiving apparatuses 51, 80 by lowering the resistance value or capacitance of the high pass filter units 52, 81 in the receiving apparatuses 51, 80 for the duration of the masking time when a fluctuation in the DC component of the differential signal is detected, the present invention is not limited thereto, and the time constant may also be lowered by lowering both the resistance value and capacitance of the high pass filter units 52, 81 in the receiving apparatuses 51, 80 for the duration of the masking time.

In addition, although the foregoing first and second embodiments explained a case of resistance value or capacitance of the high pass filter units 52, 81 in the receiving apparatuses 51, 80 only for a given period of time after the signal level of the fluctuation added signal becomes greater than the fluctuation detection threshold when a fluctuation in the DC component of the differential signal is detected, the present invention is not limited thereto, and the resistance value or capacitance of the high pass filter units 52, 81 in the receiving apparatuses 51, 80 may also be lowered for the duration that combines the period that the signal level of the fluctuation added signal is greater than the fluctuation detection threshold, and a given period of time.

Moreover, although the foregoing first and second embodiments explained a case of applying the present invention to the receiving apparatuses 51, 80 that are compliant with the Serial ATA communication standard, the present invention is not limited thereto, the present invention can also be broadly applied to various types of information detecting apparatuses for detecting information from a communication signal in which a burst period of transmitting a burst signal and a space period as a no-signal period are repeated in a pattern according to the subject matter of the information.

In addition to a receiving apparatus for detecting an OOB signal, the present invention can also be broadly applied to various types of information detecting apparatuses for detecting information from a communication signal in which a burst period of transmitting a burst signal and a space period as a no-signal period are repeated in a pattern according to the subject matter of the information.

What is claimed is:

1. An information detecting apparatus for detecting information from a communication signal in which a burst period of transmitting a burst signal and a space period as a no-signal period are repeated in a pattern according to the subject matter of the information, comprising:
a high pass filter unit configured in a manner of being able to freely change a time constant and for extracting a high frequency content of the communication signal;
a squelch detection unit for detecting a region in which a signal level of the high frequency component of the communication signal exceeds a predetermined squelch detection threshold;
an information detection unit for detecting the information superposed on the communication signal based on a detection output of the squelch detection unit;
a DC fluctuation detection unit for detecting a level fluctuation of a DC component of the communication signal;
a control unit for controlling the high pass filter to lower the time constant of the high pass filter unit when the level fluctuation of the DC component of the communication signal is detected by the DC fluctuation detection unit; and
a mask unit for masking the detection output of the squelch detection unit so as to make it appear that the squelch detection unit has not detected a region exceeding the squelch detection threshold while the control unit is lowering the time constant of the high pass filter unit.

2. The information detecting apparatus according to claim 1,
wherein the control unit controls the high pass filter unit so as to lower the time constant of the high pass filter unit for a given period of time when the DC fluctuation detection unit detects the level fluctuation of the DC component of the communication signal.

3. The information detecting apparatus according to claim 1,
wherein the high pass filter unit is configured from a resistor and a capacitor, and
wherein the control unit lowers the time constant of the high pass filter unit by lowering the resistance value of the resistor and/or the capacitance of the capacitor.

4. The information detecting apparatus according to claim 1,
wherein the communication signal is a differential signal composed of a normal phase signal and a reverse phase signal, and
wherein the DC fluctuation detection unit adds the normal phase signal and the reverse phase signal of the differential signal, and lowers the time constant of the high pass filter unit when the value of the added signals becomes a value that is outside a predetermined range.

5. The information detecting apparatus according to claim 1,
wherein the information detection unit detects an Out of Band signal defined by the Serial ATA standard.

6. An information detecting method of an information detecting apparatus including a high pass filter unit configured in a manner of being able to freely change a time constant and for extracting a high frequency content of the communication signal, a squelch detection unit for detecting a region in which a signal level of the high frequency component of the communication signal exceeds a predetermined squelch detection threshold, and an information detection unit for detecting the information superposed on the communication signal based on a detection output of the squelch detection unit, and for detecting information from a communication signal in which a burst period of transmitting a burst signal and a space period as a no-signal period are repeated in a pattern according to the subject matter of the information, comprising:
a first step of detecting a level fluctuation of a DC component of the communication signal;
a second step of controlling the high pass filter unit to lower the time constant of the high pass filter unit when the level fluctuation of the DC component of the communication signal is detected; and
a third step of masking the detection output of the squelch detection unit so as to make it appear that the squelch detection unit has not detected a region exceeding the squelch detection threshold while the time constant of the high pass filter unit is being lowered.
